(19) United States
(12) Patent Application Publication
(10) Pub. No.: US 2007/0240811 A1
(43) Pub. Date: Oct. 18, 2007

(54) Method of making a sleeved tissue product

(75) Inventors: James Leo Baggot, Menasha, WI (US); Thomas Gerard Shannon, Neenah, WI (US)

Correspondence Address: KIMBERLY-CLARK WORLDWIDE, INC.;Catherine E. Wolf, 401 NORTH LAKE STREET, NEENAH, WI, 54956, US

(73) Assignee: Kimberly-Clark Worldwide, Inc.

(21) Appl. No.: 11/404,597

(22) Filed: Apr. 13, 2006

(51) Int. Cl. B32B 37/04; B32B 37/20; B32B 38/04

(52) U.S. Cl. 156/192; 156/253; 156/271; 156/324; 156/193; 156/290

(57) ABSTRACT

A product including two or more plies with each ply including one absorbent layer and a second opposing fluid impervious layer. The two plies are arranged such that the fluid impervious layers face each other and are positioned at the inside of the two-ply product. The two plies are bonded on two or three sides to form a sleeve or a pocket, such that a hand can be inserted between the two plies and positioned in contact with one or both fluid impervious layers. In this manner, the product is absorbent on both sides, and can be utilized on both sides while preventing hand contact with the material absorbed or picked up by the product.

### BACKGROUND OF THE INVENTION

Recently, sleeved tissue products have been invented as described in commonly assigned co-pending U.S. application Ser. No. 11/138,098 filed May 26, 2005 by Shannon et al. and entitled “Sleeved Tissue Product”, which is hereby incorporated by reference. These products are particularly advantageous for wiping situations where the user wishes to protect his/her hand from contacting the material being absorbed.

However, for commercial applications, there is a need for a method of producing such products in volume, preferably at relatively high speed.

### SUMMARY OF THE INVENTION

It has now been discovered that sleeved tissue products can be made on equipment similar to that used for tissue converting processes, particularly that used for making bath tissue and paper towels.

In general, the invention resides in a method of making sleeved tissue products comprising: (a) continuously providing first and second layered webs traveling in a machine direction, each web having a hydrophilic layer and a thermoplastic hydrophobic layer; (b) passing the first and second layered webs through a heated bonding roll nip such that the hydrophobic layers of each web contact each other and the two webs become thermally bonded to each other in a grid-like bonding pattern to form a two-ply web, said grid-like bonding pattern having a plurality of substantially continuous, spaced-apart, machine direction bonded areas and a plurality of substantially continuous, spaced-apart, cross-machine direction bonded areas; (c) perforating the two-ply web within each of the cross-machine direction bonded areas to provide spaced-apart lines of perforations running in the cross-machine direction of the two-ply web; (d) slitting the two-ply web in the machine direction to provide a plurality of continuous product webs containing multiple sleeved sheets separated by lines of weakness; and (e) winding the plurality of continuous product webs into a plurality of rolls of sleeved sheets.

In another aspect, the invention resides in a method of making sleeved tissue products comprising: (a) continuously providing first and second layered webs traveling in a machine direction, each web having a hydrophilic layer and a thermoplastic hydrophobic layer; (b) passing the first and second layered webs through a heated bonding roll nip such that the hydrophobic layers of each web contact each other and the two webs become thermally bonded to each other in a grid-like bonding pattern to form a two-ply web, said grid-like bonding pattern having a plurality of substantially continuous, spaced-apart, machine direction bonded areas and a plurality of substantially continuous, spaced-apart, cross-machine direction bonded areas; (c) perforating the two-ply web within each of the cross-machine direction bonded areas to provide spaced-apart lines of perforations running in the cross-machine direction of the two-ply web; (d) slitting the two-ply web in the machine direction within each of the machine direction bonded areas and also slitting the two-ply web centrally between each of the machine direction bonded areas to provide a plurality of continuous product webs containing multiple sleeved sheets separated by lines of weakness; and (e) winding the plurality of continuous product webs into a plurality of rolls of sleeved sheets.

In another aspect, the invention resides in a method of making sleeved tissue products comprising: (a) continuously providing first and second layered webs traveling in a machine direction, each web having a hydrophilic layer and a thermoplastic hydrophobic layer; (b) passing the first and second layered webs through a heated bonding roll nip such that the hydrophobic layers of each web contact each other and the two webs become thermally bonded to each other in a grid-like bonding pattern to form a two-ply web, said grid-like bonding pattern having a plurality of substantially continuous, spaced-apart, machine direction bonded areas and a plurality of substantially continuous, spaced-apart, cross-machine direction bonded areas; (c) perforating the two-ply web within each of the cross-machine direction bonded areas to provide spaced-apart lines of perforations running in the cross-machine direction of the two-ply web; (d) slitting the two-ply web in the machine direction just outside of each of the machine direction bonded areas to provide a plurality of continuous product webs containing multiple sleeved sheets separated by lines of weakness; and (e) winding the plurality of continuous product webs into a plurality of rolls of sleeved sheets.

In another aspect, the invention resides in a method of making sleeved tissue products comprising: (a) continuously providing first and second layered webs traveling in a machine direction, each web having a hydrophilic layer and a thermoplastic hydrophobic layer; (b) passing the first and second layered webs through a heated bonding roll nip such that the hydrophobic layers of each web contact each other and the two webs become thermally bonded to each other in a grid-like bonding pattern to form a two-ply web, said grid-like bonding pattern having a plurality of substantially continuous, spaced-apart, machine direction bonded areas and a plurality of substantially continuous, spaced-apart, cross-machine direction bonded areas; (c) perforating the two-ply web within each of the cross-machine direction bonded areas to provide spaced-apart lines of perforations running in the cross-machine direction of the two-ply web; (d) winding the two-ply web into a roll; and

(e) cutting the roll in the machine direction of the sheet to provide a plurality of continuous product webs containing multiple sleeved sheets separated by lines of weakness. In this embodiment, a log saw can be used to cut the rolls after winding rather than slitting the sheets first and then winding them into rolls.

In another aspect, the invention resides in a method of making sleeved tissue products comprising: (a) continuously providing first and second layered webs traveling in a machine direction, each web having a hydrophilic layer and a thermoplastic hydrophobic layer; (b) passing the first and second layered webs through a heated bonding roll nip such that the hydrophobic layers of each web contact each other and the two webs become thermally bonded to each other in a grid-like bonding pattern to form a two-ply web, said grid-like bonding pattern having a plurality of substantially continuous, spaced-apart, machine direction bonded areas and a plurality of substantially continuous, spaced-apart, cross-machine direction bonded areas; (c) perforating the two-ply web within each of the cross-machine direction bonded areas to provide spaced-apart lines of perforations running in the cross-machine direction of the two-ply web; (d) winding the two-ply web into a roll; and (e) cutting the rolled two-ply web within each of the machine direction bonded areas of the web and also cutting the rolled two-ply web centrally between each of the machine direction bonded areas to provide a plurality of continuous product webs containing multiple sleeved sheets separated by lines of weakness.

In another aspect, the invention resides in a method of making sleeved tissue products comprising: (a) continuously providing first and second layered webs traveling in a machine direction, each web having a hydrophilic layer and a thermoplastic hydrophobic layer; (b) passing the first and second layered webs through a heated bonding roll nip such that the hydrophobic layers of each web contact each other and the two webs become thermally bonded to each other in a grid-like bonding pattern to form a two-ply web, said grid-like bonding pattern having a plurality of substantially continuous, spaced-apart, machine direction bonded areas and a plurality of substantially continuous, spaced-apart, cross-machine direction bonded areas; (c) perforating the two-ply web within each of the cross-machine direction bonded areas to provide spaced-apart lines of perforations running in the cross-machine direction of the two-ply web; (d) winding the two-ply web into a roll; and (e) cutting the rolled two-ply web just outside of each of the machine direction bonded areas to provide a plurality of continuous product webs containing multiple sleeved sheets separated by lines of weakness.

These and other aspects of the invention will be further described in connection with the drawings.

### BRIEF DESCRIPTION OF THE DRAWINGS

FIG. 1 is a schematic flow diagram of the process of this invention illustrating the steps of heat bonding, perforating, slitting and winding the product.

FIG. 2 is a schematic cross-section of the two layered webs used to form the sleeved tissue products in accordance with this invention taken along line 2-2 of FIG. 1, illustrating the hydrophobic and hydrophilic layers of the two webs.

FIG. 3 is a schematic illustration of a plan view of segment of a two-ply web made in accordance with one embodiment of the method of this invention prior to winding, illustrating the grid-like bonding pattern and the cross-machine direction lines of perforation (lines of weakness) and the machine direction slits.

FIG. 4 is a schematic illustration of a plan view of a two-ply web similar to that of FIG. 3, but made in accordance with a different embodiment of the method of this invention.

FIG. 5 is a schematic plan view of a product web made in accordance with the method of this invention, illustrating a plurality of generally rectangular sleeved tissue products separated by lines of perforation.

FIG. 5A is a schematic cross-sectional view, taken along line 5A-5A of FIG. 5.

FIG. 6 is a plan view similar to that of FIG. 5, but illustrating a different bonding pattern which results in a mitt-shaped unbonded area.

FIG. 7 is a plan view similar to that of FIGS. 5 and 6, but illustrating a bonding pattern that results in a hand-shaped unbonded area.

Repeated use of reference characters in the specification and drawings is intended to represent the same or analogous features or elements of the invention.

### DETAILED DESCRIPTION OF THE INVENTION

As used herein, forms of the words “comprise”, “have”, and “include” are legally equivalent and open-ended. Therefore, additional non-recited elements, functions, steps, or limitations may be present in addition to the recited elements, functions, steps, or limitations.

As used herein, the term “tissue” means any sheet comprising papermaking fibers and having a bulk of about 2 grams or greater per cubic centimeter. Tissue sheets particularly include any paper sheets useful for making facial tissue, bath tissue, paper towels, wipes and the like and can be made by a variety of methods known in the art.

As used herein, the term “hydrophobic layer” means that the layer repels water or prevents or substantially prevents water from passing through the layer during normal use of the product. The hydrophobicity of the surface of the hydrophobic layer can be determined by the contact angle of a drop of water placed on the hydrophobic layer. One suitable test for measuring the contact angle is ASTM D5725-99 Standard Test Method for Surface Wettability and Absorbency of Sheeted Materials Using an Automated Contact Angle Tester. The hydrophobic layers useful for the products made in accordance with the method of this invention can exhibit contact angles of about 80 degrees or greater, more specifically about 85 degrees or greater, and still more specifically about 88 degrees or greater. The degree of hydrophobicity of the hydrophobic layer can be any value as long as the hydrophobic layer retards or prevents strike-through or fluid migration into the internal space of the product during use. While in its simplest form the hydrophobic layer is a single layer of a hydrophobic material, it can also comprise hydrophilic materials, such as a hydrophilic layer that would be in contact with the user's hand during use in order to prevent a “clammy” feeling. Still, however, the overall effect of the hydrophilic layer would be to prevent passage of fluid from the outside of the product to and contacting the user's hand.

The thermoplastic hydrophobic layer can suitably comprise a polymeric film material or a non-woven or other material, such as a melt-spun web or a hydro-entangled web. The presence of a thermoplastic material in the hydrophobic layer enables the web to be thermally bonded to another like or similar web in order to form a two-ply web.

When the thermoplastic hydrophobic layer comprises a film, any suitable film may be used. Biodegradable films can be advantageous. The film may suitably be made from a homopolymer, a copolymer, a blend of polymers or a multi-layered film. In one embodiment, for instance, the film may comprise a polyolefin such as polyethylene or polypropylene. The film may have a thickness that varies greatly depending upon the particular application. For example, in one embodiment, the film may have a thickness or caliper from about 0.1 to about 10 mils, more specifically from about 0.1 to about 5 mils, and still more specifically from about 0.1 to about 2 mils.

In a specific embodiment, the film is selected from a polyethylene or polypropylene film having a basis weight of less than about 20 grams per square meter (gsm) and a caliper of about 1 mil or less. In another specific embodiment, the film is polyethylene. Polyethylene films may be preferred in some applications due to their softer feel and lower stiffness. Polyethylene films may be desirably used to avoid or reduce the crinkling sound that may occur when a polypropylene film is used and the laminated product is crumpled with the hand. While this noise does not impact the physical performance of the product, it may generate a sensory response indicating the product to be less soft and less conformable. More conformable products are believed to be better at cleaning in confined areas such as corners and curvilinear surfaces.

In some applications, there may be advantages to using a film that has a relatively high opacity. Clear film laminates may give the impression to the user of being wet during use even though fluids are prevented from passing through the film. A film having a relatively high opacity, on the other hand, provides a visual cue to the user that fluid strikethrough has not occurred. Opacity represents a substrate's light blocking ability. It can be used as a property of paper and predicts the relative visibility on one side of the paper of the images that exist on the other side. The opacity of polymer films can be measured using TAPPI procedure T 425 and/or ASTM procedure D 589. There are two different ways to report opacity, the more common being the “89% reflectance backing,” also called “contrast ratio.” This value is equal to 100 times the ratio of the diffuse reflectance of a film sample backed by a black body (<5% reflectance) to the diffuse reflectance of the same sample backed by a white body (89% reflectance). The units are percent, and a perfectly opaque material will have an opacity value of 100%. The opacity of the film, for instance, may be between about 40% to about 100%, or between about 50% to about 100%, or between about 60% to about 100%.

In other applications, it may be preferred or sufficient to use translucent films. Translucent films are measured by a haze value and not opacity. Haze is the scattering of light by a film that results in a cloudy appearance or poorer clarity of objects when viewed through the film. More technically, haze is the percentage of light transmitted through a film that is deflected more than 2.5° (degrees) from the direction of the incoming beam. A unidirectional perpendicular light beam is directed onto the film specimen, and a photo detector measures the total light transmitted by the specimen after it enters an integrating sphere. Testing for haze in films should be done by a method such as ASTM D-1003 or equivalent. A spectrophotometer may also be used provided that it meets the requirement of ASTM D-1003. Translucent films suitable for the present invention may have haze values greater than 10%, such as greater than 20%. In one specific embodiment the film may be diffusing, having a haze value greater than 30%.

In other applications, transparent films may also be used. Such films will have haze values less than 10%, such as less than 5% and specifically less than 3% when measured by ASTM D-1003 or equivalent.

As used herein, the term “hydrophilic layer” means that the layer absorbs water. It preferably comprises cellulosic fibers. It may also contain synthetic fibers, which may be surface-treated to enhance their hydrophilicity by any method known in the art. Advantageously, the hydrophilic layer is a tissue sheet. Fiber furnish selection may depend upon the particular application for which the product is intended. For example, if the product is intended to be used in paper towel type applications, the furnish may be bleached chemithermomechanical pulp, northern softwood kraft pulp, or combinations thereof. The basis weight of the hydrophilic layer may, for example, be between about 10 gsm to about 100 gsm, or between about 20 gsm to about 90 gsm, or between about 30 gsm to about 90 gsm.

The hydrophilic layer can be made by any method known in the art including air-laying, wet-laying, meltblowing, spunbonding, coforming, etc. For wet-laid layers, the hydrophilic layer can be wet-pressed, throughdried, or uncreped throughdried. Uncreped throughdried absorbent tissue layers may be preferred because of their greater wet resilience and absorbent capacity.

The absorbent capacity of the hydrophilic layer is desirably high and can be about 4 grams of water per gram of fiber (g/g), more specifically from about 4 to about 30 g/g, more specifically from about 4 to about 20 g/g, and still more specifically from about 5 to about 15 g/g. The hydrophilic layer may comprise a layer, a single ply, or multiple plies of tissue sheets and, in a desired embodiment, is a single ply.

In one embodiment, it is advantageous to use throughdried tissue, such as an uncreped throughdried tissue, as the hydrophilic layer. In a desirable embodiment, the hydrophilic layer comprises a throughdried tissue sheet having a basis weight from about 20 to about 90 gsm. In another desirable embodiment, the absorbent layer is a throughdried sheet having high wet resiliency as described in U.S. Pat. No. 6,808,790 B2, entitled “Wet-resilient Webs and Disposable Articles Made Therewith” and issued Oct. 26, 2004, to Chen et al, herein incorporated by reference.

The hydrophobic layer and the hydrophilic layer can be separate individual layers assembled from one or more materials or they may be distinct layers within a single ply material. The hydrophobic layer can be laminated or joined to the hydrophilic layer by any means known in the art. For example, films may be laminated to the absorbent layer by patterned heat embossing, hot melt-blown glue lamination, melt blowing the film directly onto the absorbent layer, adhesives, as well as other means described in the art. In one embodiment, a laminated material having a 12 gsm polypropylene sheet laminated to an 88 gsm wet-pressed tissue can be used as the first and second layered webs in the process described herein. Such a material is sold by NPS Corporation, located in Green Bay, Wis.

In various embodiments of the products made in accordance with this invention, the machine direction spacing between lines of perforation that define the width of the pocket or the sleeve can be about 4 inches or greater, more specifically from about 5 inches to about 14 inches, and still more specifically from about 6 inches to about 12 inches. The spacing should be sufficiently large to easily insert a hand into the pocket or sleeve. At the same time, the cross-machine direction distance of the product as defined between the machine direction slits can be from about 5 inches to about 14 inches, more specifically from about 5.5 inches to about 13 inches, and still more specifically from about 6 inches to about 12 inches.

### DETAILED DESCRIPTION OF THE DRAWINGS

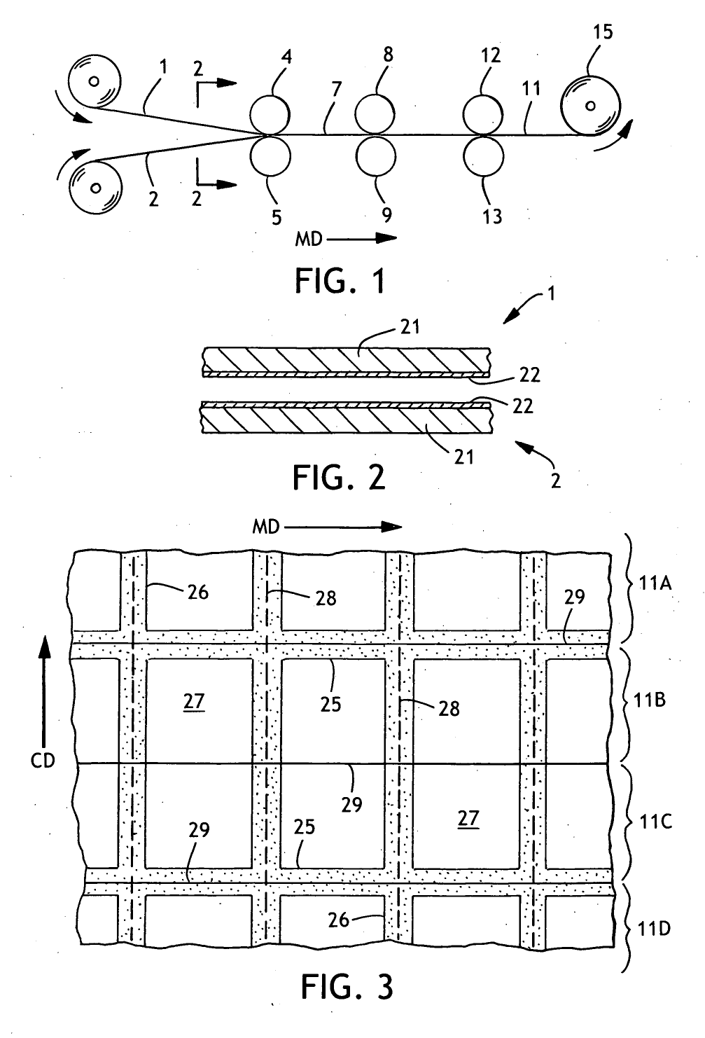

Referring to FIG. 1, shown is a schematic flow diagram of the method of this invention. Shown are two rolls of layered webs, 1 and 2, being unwound and passed into a heated bonding roll nip formed by a pair of bonding rolls 4 and 5. Because the hydrophilic layer of these products can be produced on wide tissue machines, the number of individual product webs within the cross-machine direction of the overall layered web can be from about 10 to about 50 depending upon the size of the individual products and the width of the machine making the layered webs. The resulting bonded two-ply web 7 is then perforated by passing the web between a perforation blade roll 8 and anvil roll 9. The bonded and perforated two-ply web is then slit into multiple product webs 11 as it passes through slitting rolls 12 and 13. The individual product webs are then wound into rolls 15 containing a pre-determined number of sleeved products separated by lines of weakness. Typically, the number of sleeved products within a product roll can be from about 20 to about 80, more specifically from about 40 to about 60. Each product roll can then be individually packaged as desired. Alternatively, the bonded/perforated two-ply web can be wound into rolls and thereafter cut with a log saw. Optionally, a coating station can be used, preferably after the embossing station, to apply fluids or other materials to the outside of the products in order to provide additional functionality.

FIG. 2 is a cross-sectional view of the two layered webs just prior to being thermally bonded together, taken along line 2-2 of FIG. 1. Each web contains a hydrophilic layer 21 and a thermoplastic hydrophobic layer 22. As shown, the thermoplastic hydrophobic layers are facing each other and thereafter come into contact with each other in the heated bonding roll nip.

FIG. 3 is a schematic plan view of a representative segment of the slit two-ply web of FIG. 1 showing the grid-like bonding pattern, the perforation lines and the resulting multiple product webs 11A, 11B, 11C and 11D. As shown, the bonded areas are shaded with the machine direction bonded areas being designated by reference number 25 and the cross-machine direction bonded areas being designated by reference number 26. As shown, the machine direction and the cross-machine direction bonded areas are continuous, or at least substantially continuous, and define three edges of each individual sleeved tissue product. If the bonded areas are not continuous, there may be a possibility of the final product not being entirely water-proof, which may be undesirable for some uses. Also shown are representative unbonded areas 27, the dashed perforation lines 28, and the slits 29. In this embodiment, the slits are alternately located within bonded areas and centrally within unbonded areas across the entire web. The number of resulting product webs is determined by the overall width of the base web and the desired size of the sleeved tissue product.

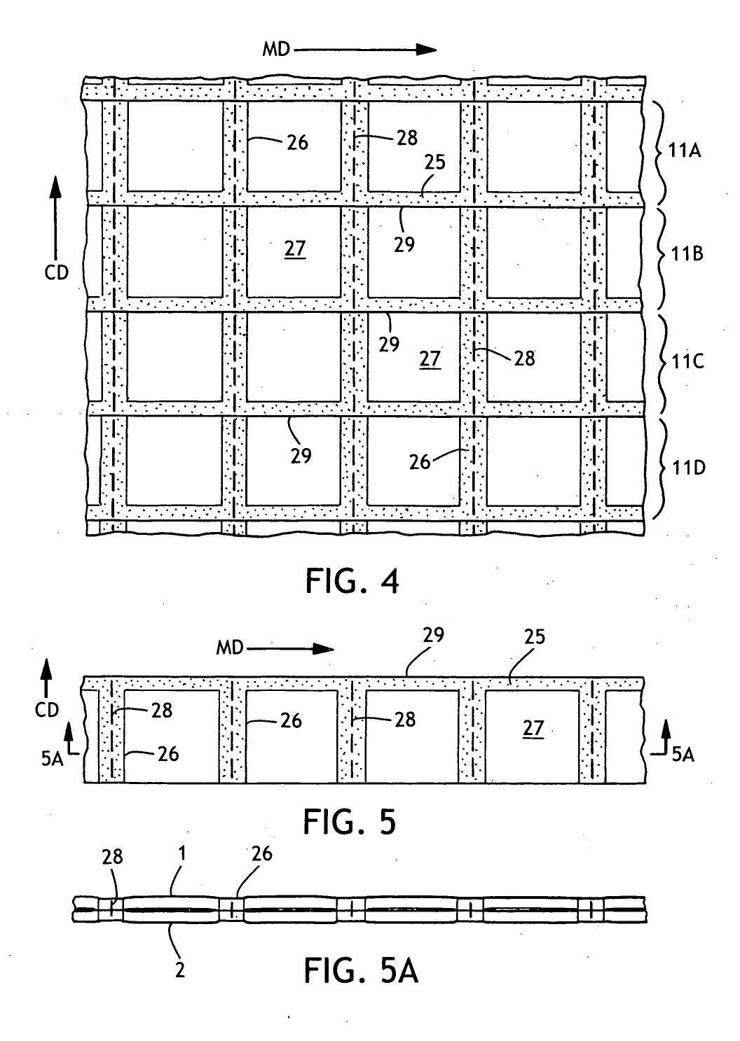

FIG. 4 is a schematic plan view of a representative segment of an alternative embodiment of the slit two-ply web of FIG. 1, in which the slits are located in the unbonded areas only and are closely positioned next to the machine direction bonded areas.

FIG. 5 is a schematic plan view of a product web containing a plurality of sleeved tissue products separated by perforation lines (lines of weakness).

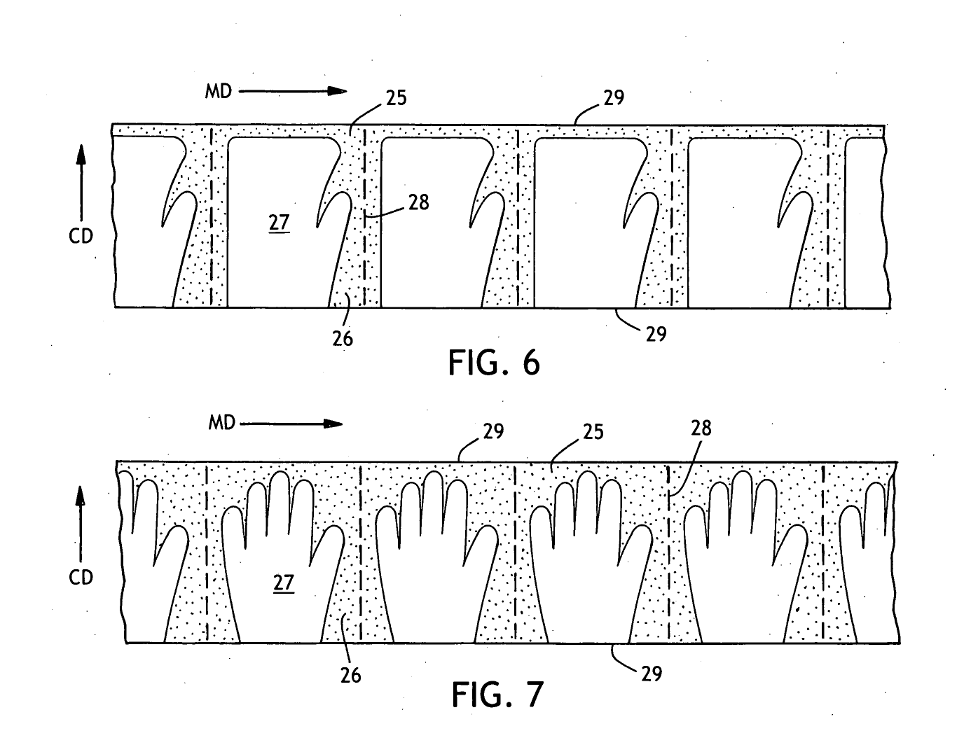

FIG. 6 is a cross-sectional view of the product web of FIG. 5, viewed from the open end of the products, further illustrating the separation of the individual sleeved tissue products by the perforation lines.

FIG. 6 is a schematic plan view of another embodiment of a product web in which the machine direction bonded areas and the cross-machine direction bonded areas combine to form an unbonded area in the shape of a mitt.

FIG. 7 is a schematic plan view of another embodiment of a product web in which the machine direction bonded areas and the cross-machine direction bonded areas combine to form an unbonded area in the shape of a hand. The embodiments having either a mitt-shaped or a hand-shaped unbonded area can be advantageous for some wiping applications where maintaining the relative position of the hand with the product is desired.

The foregoing description, given for purposes of illustration, is not to be construed as limiting the scope of the invention, which is defined by the following claims and all equivalents thereto.

We claim:

1. A method of making sleeved tissue products comprising:
(a) continuously providing first and second layered webs traveling in a machine direction, each web having a hydrophilic layer and a thermoplastic hydrophobic layer;
(b) passing the first and second layered webs through a heated bonding roll nip such that the hydrophobic layers of each web contact each other and the two webs become thermally bonded to each other in a grid-like bonding pattern to form a two-ply web, said grid-like bonding pattern having a plurality of substantially continuous, spaced-apart, machine direction bonded areas and a plurality of substantially continuous, spaced-apart, cross-machine direction bonded areas;
(c) perforating the two-ply web within each of the cross-machine direction bonded areas to provide spaced-apart lines of perforations running in the cross-machine direction of the two-ply web;
(d) slitting the two-ply web in the machine direction to provide a plurality of continuous product webs containing multiple sleeved sheets separated by lines of weakness; and
(e) winding the plurality of continuous product webs into a plurality of rolls of sleeved sheets.

2. A method of making sleeved tissue products comprising:
(a) continuously providing first and second layered webs traveling in a machine direction, each web having a hydrophilic layer and a thermoplastic hydrophobic layer;
(b) passing the first and second layered webs through a heated bonding roll nip such that the hydrophobic layers of each web contact each other and the two webs become thermally bonded to each other in a grid-like bonding pattern to form a two-ply web, said grid-like bonding pattern having a plurality of substantially continuous, spaced-apart, machine direction bonded areas and a plurality of substantially continuous, spaced-apart, cross-machine direction bonded areas;
(c) perforating the two-ply web within each of the cross-machine direction bonded areas to provide spaced-apart lines of perforations running in the cross-machine direction of the two-ply web;
(d) slitting the two-ply web in the machine direction within each of the machine direction bonded areas and also slitting the two-ply web centrally between each of the machine direction bonded areas to provide a plurality of continuous product webs containing multiple sleeved sheets separated by lines of weakness; and
(e) winding the plurality of continuous product webs into a plurality of rolls of sleeved sheets.

3. A method of making sleeved tissue products comprising:
(a) continuously providing first and second layered webs traveling in a machine direction, each web having a hydrophilic layer and a thermoplastic hydrophobic layer;
(b) passing the first and second layered webs through a heated bonding roll nip such that the hydrophobic layers of each web contact each other and the two webs become thermally bonded to each other in a grid-like bonding pattern to form a two-ply web, said grid-like bonding pattern having a plurality of substantially continuous, spaced-apart, machine direction bonded areas and a plurality of substantially continuous, spaced-apart, cross-machine direction bonded areas;
(c) perforating the two-ply web within each of the cross-machine direction bonded areas to provide spaced-apart lines of perforations running in the cross-machine direction of the two-ply web;
(d) slitting the two-ply web in the machine direction just outside of each of the machine direction bonded areas to provide a plurality of continuous product webs containing multiple sleeved sheets separated by lines of weakness; and
(e) winding the plurality of continuous product webs into a plurality of rolls of sleeved sheets.

4. A method of making sleeved tissue products comprising:
(a) continuously providing first and second layered webs traveling in a machine direction, each web having a hydrophilic layer and a thermoplastic hydrophobic layer;
(b) passing the first and second layered webs through a heated bonding roll nip such that the hydrophobic layers of each web contact each other and the two webs become thermally bonded to each other in a grid-like bonding pattern to form a two-ply web, said grid-like bonding pattern having a plurality of substantially continuous, spaced-apart, machine direction bonded areas and a plurality of substantially continuous, spaced-apart, cross-machine direction bonded areas;
(c) perforating the two-ply web within each of the cross-machine direction bonded areas to provide spaced-apart lines of perforations running in the cross-machine direction of the two-ply web;
(d) winding the two-ply web into a roll; and
(e) cutting the roll in the machine direction of the sheet to provide a plurality of continuous product webs containing multiple sleeved sheets separated by lines of weakness.

5. A method of making sleeved tissue products comprising:
(a) continuously providing first and second layered webs traveling in a machine direction, each web having a hydrophilic layer and a thermoplastic hydrophobic layer;
(b) passing the first and second layered webs through a heated bonding roll nip such that the hydrophobic layers of each web contact each other and the two webs become thermally bonded to each other in a grid-like bonding pattern to form a two-ply web, said grid-like bonding pattern having a plurality of substantially continuous, spaced-apart, machine direction bonded areas and a plurality of substantially continuous, spaced-apart, cross-machine direction bonded areas;
(c) perforating the two-ply web within each of the cross-machine direction bonded areas to provide spaced-apart lines of perforations running in the cross-machine direction of the two-ply web;
(d) winding the two-ply web into a roll; and
(e) cutting the rolled two-ply web within each of the machine direction bonded areas of the web and also cutting the rolled two-ply web centrally between each of the machine direction bonded areas to provide a plurality of continuous product webs containing multiple sleeved sheets separated by lines of weakness.

6. A method of making sleeved tissue products comprising:
(a) continuously providing first and second layered webs traveling in a machine direction, each web having a hydrophilic layer and a thermoplastic hydrophobic layer;
(b) passing the first and second layered webs through a heated bonding roll nip such that the hydrophobic layers of each web contact each other and the two webs become thermally bonded to each other in a grid-like bonding pattern to form a two-ply web, said grid-like bonding pattern having a plurality of substantially continuous, spaced-apart, machine direction bonded areas and a plurality of substantially continuous, spaced-apart, cross-machine direction bonded areas;
(c) perforating the two-ply web within each of the cross-machine direction bonded areas to provide spaced-apart lines of perforations running in the cross-machine direction of the two-ply web;
(d) winding the two-ply web into a roll; and
(e) cutting the rolled two-ply web just outside of each of the machine direction bonded areas to provide a plurality of continuous product webs containing multiple sleeved sheets separated by lines of weakness.

7. The method of claim 1, 2, 3, 4, 5 or 6 wherein the grid-like bonding pattern defines an unbonded area in the shape of a rectangle.

8. The method of claim 1, 2, 3, 4, 5 or 6 wherein the grid-like bonding pattern defines an unbonded area in the shape of a mitt.

9. The method of claim 1, 2, 3, 4, 5 or 6 wherein the grid-like bonding pattern defines an unbonded area in the shape of a hand.

10. The method of claim 1, 2, 3, 4, 5 or 6 wherein the hydrophobic layer comprises cellulosic papermaking fibers and the hydrophobic layer is a film.

11. The method of claim 1, 2, 3, 4, 5 or 6 wherein the hydrophobic layer is a nonwoven fibrous web.
